(19) United States
(12) Patent Application Publication
(10) Pub. No.: US 2005/0233055 A1
(43) Pub. Date: Oct. 20, 2005

(54) Dressings comprising emulsified liquid shortening compositions comprising dietary fiber gel, water and lipid

(75) Inventors: Triveni Shukla, New Berlin, WI (US); Gregory Halpem, Vernon Hills, IL (US)

Correspondence Address: Circle Group Holdings, Inc., 1011 Campus Drive, Mundelein, IL, 60060, US

(73) Assignee: Circle Group Holdings, Inc.

(21) Appl. No.: 11/152,655

(22) Filed: Jun. 14, 2005

Related U.S. Application Data
(63) Continuation-in-part of application No. 10/689,267, filed on Oct. 20, 2003.

(51) Int. Cl. A23L 1/05

(52) U.S. Cl. 426/602

(57) ABSTRACT

According to the present invention, fat and caloric content of dressings can be reduced by the replacement of a portion fat content normally found in dressings with an amount of emulsified liquid shortening composition comprising amorphous insoluble cellulosic fiber gel, water and lipid. The result is that fat and caloric content of dressings can be manipulated with minimal effect on taste and texture. Furthermore, these emulsified mixtures, or “emulsified liquid shortening compositions comprising amorphous insoluble cellulosic fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof Hence, in addition to reducing fat and caloric content of dressings, further health benefits can be achieved by replacing a portion of fat with emulsified liquid shortening compositions comprising amorphous insoluble cellulosic fiber gel, water and lipid.

### B. CROSS-REFERENCE TO RELATED APPLICATIONS

This application is a Continuation-in-Part Application of U.S. patent application Ser. No. 10/689267 filed on Oct. 20, 2003, the entirety of which is incorporated herein.

### C. TECHNICAL FIELD

The present invention generally relates to the field of food science and more specifically to dressings comprising amorphous insoluble cellulosic fiber compositions.

### D. BACKGROUND ART

The present invention relates to dressings comprising emulsified liquid shortening compositions comprising amorphous insoluble cellulosic fiber gel, water and lipid. Recent media attention to the global problem of obesity demonstrates a need for greater availability of foods with low caloric and fat content. This is especially true for foods that typically have high fat and caloric content, such as dressings.

Dressings typically comprise some fat. Other ingredients can vary according to the type of dressing and the recipe followed, but typically, dressings are high in both fat and caloric content.

In recent years, some companies have begun to offer reduced fat dressings. This variety of dressing, however, often fails to retain the desirable taste and texture of dressings comprising higher fat contents.

The absence of a means to reduce the fat and caloric content of dressings while still producing a desirably flavored and textured dressing presents an unmet need in today's food industry.

### E. DISCLOSURE OF THE INVENTION

It is an object of the present invention to provide a unique composition of matter embodied by low-calorie and low-fat dressings. This reduction in caloric and fat content answers an unmet need in the food industry to provide the consuming public with a healthier, higher fiber alternative to traditional types of dressings that typically are inherently fattening. It is another object of the present invention to provide dressings that have been fortified with insoluble fiber and other functional foods.

Amorphous insoluble cellulosic fiber gels for calorie reduced foods hold the key to meeting this need. Dietary fiber gels for calorie reduced foods are fully described in U.S. Pat. No. 5,766,662 (the '662 patent), which is incorporated in its entirety herein. These amorphous insoluble cellulosic fiber gels comprise insoluble amorphous insoluble cellulosic fibers consisting of morphologically disintegrated cellular structures, and are characterized by their ability to retain large amounts of water. The amorphous insoluble cellulosic fiber gels are produced by shearing agricultural by-products, such as seed brans, hulls, and so forth, under alkaline conditions. Amorphous insoluble cellulosic fiber gels in a hydrated form can exist as a gel, and in dehydrated form as flakes and powders. Additionally, these amorphous insoluble cellulosic fiber gels are characterized by their high viscosity at low solid levels. Other insoluble fibers derived from cereals, grains and legumes consist of morphologically intact cellular structures, and generally are of microcrystalline form; thus they impart a gritty texture to the foods in which they are contained. The amorphous insoluble cellulosic fiber gels disclosed in the '662 patent, however, are amorphous in nature and consist of morphologically disintegrated cellular structures; they thus impart a smoother texture than other insoluble fiber formulations. A physically smooth morphology is readily revealed under electron microscopic magnification of amorphous insoluble cellulosic fiber gel. The smooth morphology is also demonstrated by approximately 60 percent to 90 percent reduction in birefringence when compared to microcrystalline dietary fiber products. The smooth morphology reflects the amorphous nature of the insoluble compounds that constitute amorphous insoluble cellulosic fiber gel.

More specifically, the present invention utilizes emulsified mixtures of the amorphous insoluble cellulosic fiber gels disclosed in the '662 patent, the emulsified mixtures further comprising, at a minimum, water and lipid. These emulsified mixtures are fully described in and are the subject of U.S. patent application Ser. No. 10/669731, filed Sep. 24, 2003 which is herein incorporated by reference in its entirety. These emulsified mixtures, or “emulsified liquid shortening compositions comprising amorphous insoluble cellulosic fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof Hence, in addition to reducing fat and caloric content of dressings, further health benefits can be achieved by replacing a portion of fat with emulsified liquid shortening compositions comprising amorphous insoluble cellulosic fiber gel, water and lipid.

According to the present invention, fat and caloric content can be reduced by the replacement of the fat normally found in dressings with emulsified liquid shortening compositions comprising amorphous insoluble cellulosic fiber gel, water and lipid. This replacement of fat does not adversely affect either the taste or texture of the dressings. The result is that fat and caloric content of dressings can be manipulated with minimal effect on taste and texture, and as stated above, additional health benefits can be achieved through consumption of dressings comprising emulsified liquid shortening compositions comprising amorphous insoluble cellulosic fiber gel, water and lipid when functional foods are included in the formulations.

Further objects, advantages and features of the present invention will present themselves in the following detailed description.

### F. BEST MODE FOR CARRYING OUT THE INVENTION

This invention is directed to dressings comprising emulsified liquid shortening compositions comprising amorphous insoluble cellulosic fiber gel, water and lipid. According to the present invention, fat and caloric content can be reduced by the replacement of fat normally found in dressings with emulsified liquid shortening compositions comprising amorphous insoluble cellulosic fiber gel, water and lipid (hereinafter “emulsified liquid shortening”). This replacement of fat does not adversely affect either the taste or texture of the dressings. The result is that fat and caloric content of dressings can be manipulated with minimal effect on taste and texture.

Alternatively, the dressings can be provided in the form of dressing mixes with the intention that a consumer can mix them at a convenient, post-purchase time, and dressing mixes are considered to be within the scope of this invention. As such, for purposes of this document, the term “dressings” is defined to include dressing mixes.

Different categories of dressing are available to consumers, including creamy-type dressings, vinaigrette-type dressings, and mayonnaise. Vinaigrette dressings, for example Italian, oil and vinegar, and the like, can be formulated such that the dressing comprises 0.1 percent to 0.5 percent amorphous insoluble cellulosic fiber gel solids by replacing an appropriate amount, that is, prorated to deliver this range of amorphous insoluble cellulosic fiber gel solids, of fat, including oil and liquid shortening, with an amount of emulsified liquid shortening. Creamy dressings, for example ranch, blue cheese, creamy Italian, and the like, as well as mayonnaise, can be formulated such that the dressing comprises 0.1 percent to 3.0 percent amorphous insoluble cellulosic fiber gel solids by replacing an appropriate amount, that is, prorated to deliver this range of amorphous insoluble cellulosic fiber gel solids, of fat, including oil and liquid shortening, with an amount of emulsified liquid shortening.

The result is that fat and caloric content of dressings can be manipulated with minimal effect on taste and texture, and as stated above, additional health benefits can be achieved through consumption of dressings comprising emulsified liquid shortening compositions comprising amorphous insoluble cellulosic fiber gel, water and lipid when functional foods are included in the formulations.

### EXAMPLE 1

### Vinaigrette Salad Dressing Comprising Emulsified Liquid Shortening Compositions Comprising Dietary Fiber Gel, Water and Lipid

TABLE 1

| | | With | Without |
|---|---|---|---|
| | Water | 25 | 00 |
| 1. | Vinegar, gram | 162 | 121.4 |
| | Sesame Oil | 75 | 151.6 |
| 2. | Sugar, gram | 140 | 161.5 |
| 3. | Emulsified Liquid Shortening | 20 | 00 |
| 4. | Soy sauce, gram | 70 | 60.9 |
| 5. | Garlic Powder | 18 | 14.2 |
| | Total | 510 | 510 |
| | The dressing with Emulsion has 45.6% less fat | 16.20 | 29.76 |
| | and comprises 0.94% Fiber Gel solids. | | |

Two formulations of vinaigrette salad dressing are presented in Table 1. One dressing formulation, labeled here as “Without”, represents a typical formulation for salad dressing. A second dressing formulation, labeled here as “With” demonstrates a variation on the “Without” formulation and comprises Emulsified Liquid Shortening Compositions Comprising Dietary Fiber Gel, Water and Lipid. The formulation comprising Emulsified Liquid Shortening Compositions Comprising Dietary Fiber Gel, Water and Lipid exhibits a 45.6% reduction in fat compared to its counterpart formulation and comprises 0.94% (by weight) Fiber Gel solids.

### EXAMPLE 2

### Creamy Italian Dressing Comprising Emulsified Liquid Shortening Compositions Comprising Dietary Fiber Gel, Water and Lipid

TABLE 2

| | |
|---|---|
| Salt (g) | 15.00 |
| Vinegar (g) | 140.00 |
| Fructose (g) | 15.00 |
| Emulsified Liquid Shortening (g) | 16.60 |
| Sugar (g) | 13.00 |
| Garlic Powder (g) | 4.00 |
| Citric Acid (g) | 3.40 |
| Dry Mustard (g) | 1.60 |
| Basil (g) | 1.55 |
| Parsley (g) | 1.25 |
| Onion Powder (g) | 1.00 |
| Black Pepper (g) | 1.00 |
| Paprika (g) | 0.62 |
| Titanium Dioxide (g) | 0.33 |
| Oregano (g) | 0.31 |
| TOTAL | 214.66 |

Table 2 demonstrates a low fat formulation for Creamy Italian Dressing. To make the dressing, all dry ingredients can be mixed together thoroughly. Add the mixture of dry ingredients to the vinegar and Emulsified Liquid Shortening. Mix at high speed. This is a 2.94% fat creamy-style dressing.

1. Vinaigrette dressing, the dressing having a formulation, the dressing comprising emulsified liquid shortening composition comprising amorphous insoluble cellulosic fiber gel, water and lipid,
wherein the emulsified liquid shortening composition comprising amorphous insoluble cellulosic fiber gel, water and lipid is added in a prorated amount such that solids contained within the amorphous insoluble cellulosic fiber gel represent 0.1 percent to 1.8 percent by weight of the overall dressing formulation, and
the emulsified liquid shortening composition comprising amorphous insoluble cellulosic fiber gel, water and lipid replaces an amount of fat used in an otherwise identical recipe of vinaigrette dressing that uses no emulsified liquid shortening compositions comprising amorphous insoluble cellulosic fiber gel, water and lipid.

2. Creamy dressing, the dressing having a formulation, the dressing comprising emulsified liquid shortening composition comprising amorphous insoluble cellulosic fiber gel, water and lipid,
wherein the emulsified liquid shortening composition comprising amorphous insoluble cellulosic fiber gel, water and lipid is added in a prorated amount such that solids contained within the amorphous insoluble cellulosic fiber gel represent 0.1 percent to 3.0 percent by weight of the overall dressing formulation, and
the emulsified liquid shortening composition comprising amorphous insoluble cellulosic fiber gel, water and lipid replaces an amount of fat used in an otherwise identical recipe of creamy dressing that uses no emulsified liquid shortening compositions comprising amorphous insoluble cellulosic fiber gel, water and lipid.

3. Mayonnaise, the mayonnaise having a formulation, the mayonnaise comprising emulsified liquid shortening composition comprising amorphous insoluble cellulosic fiber gel, water and lipid,
wherein the emulsified liquid shortening composition comprising amorphous insoluble cellulosic fiber gel, water and lipid is added in a prorated amount such that solids contained within the amorphous insoluble cellulosic fiber gel represent 0.1 percent to 3.0 percent by weight of the overall mayonnaise formulation, and
the emulsified liquid shortening composition comprising amorphous insoluble cellulosic fiber gel, water and lipid replaces an amount of fat used in an otherwise identical recipe of mayonnaise that uses no emulsified liquid shortening compositions comprising amorphous insoluble cellulosic fiber gel, water and lipid.

4. Vinaigrette dressing mix, the mix having a formulation, the mix comprising emulsified liquid shortening composition comprising amorphous insoluble cellulosic fiber gel, water and lipid,
wherein the emulsified liquid shortening composition comprising amorphous insoluble cellulosic fiber gel, water and lipid is added in a prorated amount such that solids contained within the amorphous insoluble cellulosic fiber gel represent 0.1 percent to 0.5 percent by weight of the overall dressing formulation as reconstituted, and
the emulsified liquid shortening composition comprising amorphous insoluble cellulosic fiber gel, water and lipid replaces an amount of fat used in an otherwise identical recipe of vinaigrette dressing mix that uses no emulsified liquid shortening compositions comprising amorphous insoluble cellulosic fiber gel, water and lipid.

5. Creamy dressing mix, the mix having a formulation, the mix comprising emulsified liquid shortening composition comprising amorphous insoluble cellulosic fiber gel, water and lipid,
wherein the emulsified liquid shortening composition comprising amorphous insoluble cellulosic fiber gel, water and lipid is added in a prorated amount such that solids contained within the amorphous insoluble cellulosic fiber gel represent 0.1 percent to 3.0 percent by weight of the overall dressing formulation as reconstituted, and
the emulsified liquid shortening composition comprising amorphous insoluble cellulosic fiber gel, water and lipid replaces an amount of fat used in an otherwise identical recipe of creamy dressing mix that uses no emulsified liquid shortening compositions comprising amorphous insoluble cellulosic fiber gel, water and lipid.
